(19) United States
(12) Patent Application Publication
(10) Pub. No.: US 2003/0205631 A1
(43) Pub. Date: Nov. 6, 2003

(54) Spraying of liquids

(75) Inventors: Bradford Scott Barron, Cincinnati, OH (US); Joseph Fernand Deflander, Wespelaar (BE); Pedro Vincent Vandecappelle, Izegem (BE); Nadejda Balandina, Strombeek-Bever (BE); Christian Gerhard Friedrich Gerlach, Brussels (BE); Kris Frans Gabriel Van Bosstraeten, Reet (BE); Chris Van den Wouwer, Deurne (BE); Neil Archibald MacGilp, Bramley (GB)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/303,400

(22) Filed: Nov. 25, 2002

Related U.S. Application Data
(63) Continuation of application No. PCT/US01/16691, filed on May 23, 2001.

(30) Foreign Application Priority Data
May 25, 2000 (GB) 0012563.3
May 25, 2000 (GB) 0012640.9
Feb. 24, 2001 (GB) 0104649.9
Feb. 24, 2001 (GB) 0104667.1

(51) Int. Cl. B05B 5/00

(52) U.S. Cl. 239/690

(57) ABSTRACT

A method and equipment for applying a liquid product onto a household article or plant for purpose of cleaning, wetting, coating, polishing, fabric treatment, plant watering and the like, the method comprising discharging the liquid through a spray nozzle in the form of an upwardly or downwardly directed spray of droplets having an average droplet size of at least about 40 μm and preferably in the range from about 75 to about 500 μm and at a proximal distance of from about 0.1 to about 1 m from the household article or plant, the liquid being discharged through the spray nozzle at an exit velocity in the range from about 3 to about 80 m/s, preferably from about 3 to about 20 m/s (when the spray droplets are upwardly directed) and from about 0 to about 2 m/s (when the spray droplets are downwardly directed) and at an applied potential in the range from about 0.2 to about 50 kV, whereby the overspray is less than about 40%. The equipment preferably comprises a nozzle having a multi-jet spray head, means for adjusting the orientation of the nozzle and grounding means for charge dissipation. The method and equipment provide effective coverage of household objects/plants and avoid spoil and waste of the liquid in the surroundings of the household object/plant.

### CRESS REFERENCE TO PRIOR APPLICATION

This is a continuation of International Application PCT/US01/16691, with an international filing date of May 23, 2001, and published in English.

### TECHNICAL FIELD

This invention relates to a method and equipment for delivering a fluent material, especially a liquid product onto a household article or household plant. More particularly, the invention relates to a method and equipment for applying a liquid product onto a household article for purpose of cleaning, wetting, coating, polishing, fabric treatment and the like, using a spray generated by electrostatic or a combination of electrostatic and hydrodynamic forces. The invention also relates to a method and equipment for watering household plants. The method and equipment of the invention provide effective liquid delivery and watering of plants together with mess- and drip-free operation, improved safety and reduced overspray.

### BACKGROUND OF THE INVENTION

Electrostatic spraying and electrodeposition of liquids is well known in the art. Electrostatic spraying is based on the generation of charged droplets and their delivery onto a grounded target surface. An advantage of electrostatic spray over other spray techniques results from the fact that the electrical field generated by charged droplets gives rise to a very uniform distribution of the liquid being sprayed. Another advantage of electrostatic spray is the ability to wrap around the surface being sprayed and to increase the amount of liquid deposited onto the target. Electrostatic spray has a wide range of applications. It is used, for example: i) industrially to coat an active material, such as paint onto a surface (e.g., U.S. Pat. No. 5,208,078 and U.S. Pat. No. 5,443,642); ii) in agriculture for deliver of pesticides onto crops (e.g., GB-A-1,569,707 and U.S. Pat. No. 4,356,528) and iii) at a personal level to deliver cosmetic and personal care products (e.g., U.S. Pat. No. 5,945,111).

The prior art (e.g., GB-A-1,569,707 and U.S. Pat. No. 4,356,528) teaches that suitable electrostatic spray for agricultural use is attained when the size of the spray droplets is in the aerosol particle size range, e.g. below about 50 μm. This fact limits the range of liquids that can be successfully sprayed as well as the range of flow rates that can be achieved. The teaching from the prior art is that, with many systems, only high resistivity liquids can be sprayed at practical flow rates. Another limitation found with known electrostatic spray systems is that charged particles tend to seek the closest earthed object to discharge their electrical charge, therefore they are not appropriate for use in household or other closed environments.

For these and other reasons, electrostatic spray has not been applied commercially in the household environment for treatment of household articles. However, the use of electrostatic spray in the household environment could be highly beneficial when a selective and uniform coverage of surfaces is required, e.g., cleaning products onto ornamental objects or furniture, fabric treatment products onto clothes, bedding, linen and the like, etc.

The application of electrostatic spray techniques could be especially beneficial in the household environment for watering of plants. Users often find that they need to take their plants outside when spraying plant care products if they wish to avoid liquid landing on the plant surroundings. However, the existing electrostatic spray systems are not adequate for use in a domestic or closed environment to apply water, plant care products, hard surface cleaning or treatment products, etc. This is due to a number of reasons: i) plant care and household cleaning products are usually aqueous and have low resistivity therefore they cannot be sprayed with existing hand held electrostatic devices, such as those used for cosmetics applications; ii) potted plants and other articles commonly found in house interiors are not grounded, charge dissipation taking place directly or indirectly via the operator which is both potentially unsafe and leads to poor spray characteristics; iii) conventional electrostatic spray systems used in agriculture have high flow rates and high velocities, possibly attained with the use of air-assistance, and thus are not selective enough to deposit significant quantities of liquid whilst avoiding the deposition of liquid onto the surroundings; iv) conventional electrostatic spray systems are not generally designed to be mess- or drip-free or to the extent necessary to ensure safe and effective operation in a domestic environment, for example they may include nozzle systems that readily clog with foreign matter or which are difficult to clean or which display poor spray characteristics, especially at the start and end of spraying; and v) conventional electrostatic spray systems are not generally designed from the ergonomic, electrical and control viewpoint so as to be easy and safe to use in a domestic situation.

Accordingly the present invention provides in one or more embodiments electrostatic spray equipment and methods that allow for effective and selective spraying of individual household items in a domestic environment with reduced overspray, that have mess- and drip-free operation, that include grounding mechanisms that ensure operator safety and effective spray delivery, that are ergonomically designed, and that include mechanisms for control of the equipment to improve the safety thereof and the effectiveness of the equipment for spraying household items.

### SUMMARY OF THE INVENTION

According to a first aspect of the invention, there is provided electrostatic spray equipment for use in spraying a liquid onto a household article or plant for the purpose of cleaning, wetting, coating, polishing, fabric treatment, plant watering and the like, the spray equipment comprising:

a) a reservoir for containing the liquid;

b) a nozzle in fluid communication with the reservoir having at least one orifice for generating a spray of droplets;

c) means for delivering the liquid from the reservoir to the nozzle;

d) means for controlling the spray equipment; and

e) means for electrically charging the liquid.

The means for electrically charging the liquid preferably comprises a generator having high and low voltage outputs and in preferred embodiments is electrically isolated from the operator/user. In addition, the spray equipment preferably also includes means for grounding the household article or plant for the purpose of charge dissipation. Preferably, the means for grounding comprises: i) a connector in electrical contact with the low voltage output of the generator and which is maintained at low or zero electrical potential; and ii) a pin, spike or other fastening means in electrical contact with the household article or plant and which is capable of being electrically isolated from the connector and from ground.

In use, the connector and fastening means are brought into electrical connection in order to establish a charge-dissipation grounding loop. For this purpose, the electrostatic spray equipment preferably includes means associated with either or both of said connector and fastening means for electrically connecting said connector and fastening means, said means for electrically connecting being selected from mechanical connection means such as mechanical clips and male-female connectors, magnetic connection means, electromagnetic connection means, and the like.

The connector itself can take the form of or comprise an electrically-conductive wire, the length of which can be selected to control the maximum permissible spraying distance between the equipment and the household article or plant. Alternatively, the wire can be marked with indicia to provide the user with a visual indication of the spraying distance.

The fastening means, on the other hand, preferably takes the form of a pin, spike or peg of generally cylindrical shape, although other means for providing electrical contact with the household article or plant are suitable herein including generally flat or planar plates, adhesive strips, etc. The pin or other fastening means should be formed of a material that is non-corrosive in the application environment (e.g. the soil). Furthermore, the pin or other fastening means can provide other functionality, for example, it can act as a plant feeding stick or can form part of a ‘smart advising system’ as described in detail below.

The electrostatic spray equipment can also includes various means for controlling the equipment, including one or more of the following:

a) means for switching the equipment on or off;

b) means for regulating delivery of the liquid from the reservoir to the nozzle;

c) means for regulating spray characteristics, for example application rate, spray direction, trajectory, shape and size of spray pattern, etc;

d) means for storing operational and/or environmental information; and

e) means for computing optimum operational characteristics dependant upon said operational and/or environmental information.

In addition, the spray equipment according to the invention can comprise means for providing feedback of operational or environmental information to the spray equipment control means or to the user for the purpose of controlling the equipment or for advising the user of operational and/or environmental conditions. Suitably, the means for providing feedback comprises means associated with the fastening means and/or connector for sensing operational and/or environmental conditions and means for communicating information generated by the sensing means to the spray equipment control means and/or to the user. Suitable means for communicating information includes wire-based communication means, optical fibre communication means, radio communication means such as Bluetooth, infra-red communication means, etc.

In preferred embodiments, the means for sensing comprises means associated with the fastening means for one or more of the following functions:

a) switching the spray equipment on or off;

b) regulating delivery of the liquid from the reservoir to the nozzle;

c) regulating spray characteristics;

d) providing operational and/or environmental data, for example monitoring humidity, temperature, soil pH, moisture, salinity, nutrients, etc; and

e) preventing the spray equipment from switching on unless the connector is electrically connected to the fastening means.

The present invention also relates to a method of spraying a liquid onto a household article or plant for the purpose of cleaning, wetting, coating, polishing, fabric treatment, plant watering and the like. In a preferred aspect, the method comprises the use of spray equipment comprising:

a) a reservoir for containing the liquid;

b) a nozzle in fluid communication with the reservoir having at least one orifice for generating a spray of droplets;

c) means for delivering the liquid from the reservoir to the nozzle;

d) means for controlling the spray equipment

e) means for electrically charging the liquid, said means comprising a generator having high and low voltage outputs; and

f) means for grounding the household article or plant for purpose of charge dissipation, said means for grounding comprising a connector in electrical contact with the low voltage output of the generator and which is maintained at low or zero electrical potential;

the method further comprising

i) bringing the household article or plant into electrical contact with a pin or other fastening means which is electrically isolated from the connector and from ground; and

ii) bringing the connector and fastening means into electrical connection in order to establish a charge-dissipation grounding loop.

The electrostatic spray equipment herein also comprises a nozzle in fluid communication with the reservoir for generating a spray of droplets. While suitable nozzles can comprise one or more orifices, highly preferred herein from the viewpoint of mess- and drip-free spray characteristics is a nozzle that comprises a multi-jet spray-head having a plurality of orifices adapted to discharge the liquid under a combination of electrostatic and hydrodynamic forces and preferably in a plurality of non-capillary flow paths.

Thus, according to another aspect of the invention, there is provided electrostatic spray equipment for use in spraying a liquid onto a household article or plant for the purpose of cleaning, wetting, coating, polishing, fabric treatment, plant watering and the like; the spray equipment comprising:

a) a reservoir for containing the liquid;

b) a nozzle in fluid communication with the reservoir for generating a spray of droplets and wherein the nozzle comprises a multi-jet spray-head having a plurality of orifices adapted to discharge the liquid under a combination of electrostatic and hydrodynamic forces;

c) means for hydrodynamically delivering the liquid from the reservoir to the nozzle; and

d) means (including an electrode) for electrically charging the liquid.

Preferably, the multi-jet spray-head comprises form about 2 to about 200, preferably from about 3 to about 60 orifices and each orifice has an outlet diameter in the range from about 10 μm to about 250 μm, preferably from about 20 μm to about 100 μm. Especially preferred for use herein is a spray-head comprising form about 5 to about 20, preferably from about 6 to about 13 orifices wherein each orifice has an outlet diameter in the range from about 22 μm to about 60 μm, preferably from about 25 μm to about 50 μm. The orifices are preferably of a non-capillary type whereby they are capable of discharging liquid in a plurality of non-capillary flow paths. By non-capillary is meant that the orifices have a length:width ratio on average of no more than about 50:1, preferably no more than about 20:1.

In addition, the average spacing between neighbouring orifices of the spray-head is preferably in the range from about 100 μm to about 20 mm, more preferably from about 1.5 to about 10 mm, this being desirable from the viewpoint of minimizing electrostatic interference between the corresponding neighbouring jets and for ensuring that the liquid is discharged in mess-free manner and in a narrow spray cone.

In preferred embodiments, the nozzle comprises an assembly of components including a spray-head and one or more additional nozzle components. The assembly is preferably constructed in such a way that it can be dissembled as necessary for cleaning or servicing purposes. One preferred additional nozzle component is a filter introduced for the purpose of reducing clogging of the spray-head and for preventing damage thereto. Preferably, the design of the nozzle is such that the filter and spray-head are detachable either separately or as a unit from the remainder of the assembly for the purpose of cleaning or replacement thereof. For this purpose, the filter and spray-head are preferably mounted downstream of the liquid-charging electrode means.

In preferred embodiments, the nozzle additionally incorporates means for reducing dripping of liquid during and especially at the start and end of spraying, said means comprising a pressure control valve used in conjunction with hydraulic pump means and which is responsive to an increase or decrease in pressure respectively above and below given trigger and cut-off threshold values so as to control the flow of liquid through the nozzle. The pressure control valve preferably has trigger and cut-off threshold values of from about 5% to about 50%, more preferably from about 6% to about 20%, yet more preferably from about 8% to about 15%, and most preferably about 10% respectively above and below the operating flow pressure of the spray equipment, these threshold values being particularly important in the case of spray equipment based on peristaltic or other pump types which seal hydraulically at rest. The pressure control valve is also preferably mounted in the nozzle assembly in the vicinity (preferably immediately upstream) of the spray-head, which leads to better valve control and reduced dripping at the start and end of spraying. Once again in preferred embodiments the liquid-charging electrode means is positioned upstream of the pressure control valve. Embodiments in which the pressure control means is located upstream of the nozzle assembly itself are also envisaged herein, though such embodiments are less preferred.

Thus, according to a further aspect of the invention, there is provided electrostatic spray equipment for use in spraying a liquid onto a household article or plant for the purpose of cleaning, wetting, coating, polishing, fabric treatment, plant watering and the like, the spray equipment comprising: a) a reservoir for containing the liquid; b) a nozzle in fluid communication with the reservoir for generating a spray of droplets; and c) means for delivering the liquid from the reservoir to the nozzle, said means preferably comprising hydraulic and especially peristaltic pump means; and wherein the nozzle comprises an assembly of nozzle components including:

i) a spray-head having one or more orifices adapted to discharge the liquid in the form of a spray;

ii) a filter for preventing or reducing clogging of the spray-head;

iii) means for reducing dripping of liquid during and especially at the start and end of spraying, said means comprising a pressure control valve responsive to an increase or decrease in pressure respectively above and below given trigger and cut-off threshold values so as to control the flow of liquid through the nozzle, said pressure control valve preferably being mounted in the vicinity of the spray-head; and

iv) means for electrically charging the liquid.

As described herein, the spray-head and filter are preferably detachable from the remainder of the assembly including the pressure control valve and the means for electrically charging the liquid for the purpose of cleaning or replacement thereof.

Alternatively, pressure control can be achieved using an orifice in the form of a slit seal valve, i.e. a slit (preferably x-shaped) in the surface of an elastomeric membrane which has a trigger or cracking pressure such as to allow normal jet formation to take place without cracking but which cracks or opens by inversion of the membrane at pressures above the cracking pressure caused by the presence of clogging material. Spray equipment comprising a nozzle having one or more orifices in the form of a slit-seal valve thus comprise another separate and valuable aspect of the invention.

The orifices themselves (including slit-seal orifices) can be made by conventional micromachining, laser drilling, photoetching or similar techniques. The manufacture of multi-jet spray heads is complex, however, and presents a number of difficulties using the known techniques. An alternative approach to making multi-jet spray-heads is to make a series of grooves or ridges in a plate which is then brought into sealing engagement with a second plate so as to form a series of channels between the plates. By using plates in cylindrical form and dimensioned to provide sealing engagement between the plates, this approach allows the manufacture of a multi-jet head of generally circular configuration with a series of orifices set around the circumference of the cylinder.

The electrostatic spray equipment herein preferably also includes means associated with the nozzle for regulating and adjusting the spray pattern, said means being selected from (1) means for selecting the number of orifices of a given diameter, (2) means for changing orifice diameter, (3) means for selecting a mix of orifices of differing diameter, and (4) means for adjusting orifice cross sectional shape so as to change the diameter of the resulting jet (for example, means for lengthening or shortening one dimension of an oval cross-section).

In a preferred nozzle assembly, the filter, pressure control valve and spray-head are mounted within a housing equipped with a fluid inlet port and high voltage supply port at the inlet end of the housing and with a detachable hood or shroud at the outlet end of the housing and which acts as a deflector or shaping device for the spray as described in detail hereinbelow. The hood or shroud is secured to the housing by screw or similar engagement means on the outlet end of the housing and is detachable from the housing in order to permit disassembly of the nozzle. The spray-head is mounted at the outlet end of the housing and comprises an orifice portion, a sleeve portion and a circumferential lip portion. The filter is mounted at the inlet end of the housing and comprises a filter element and a filter holder having an annular flange. The pressure control valve is mounted intermediate the spray-head and the filter. When assembled, the hood or shroud bears on the circumferential lip portion of the spray-head while the outermost portion of the annular flange of the filter holder bears on the sleeve portion of the spray-head, whereby the hood or shroud and the filter holder together act to hold the spray-head in position within the housing. The pressure control valve on the other hand is mounted with one end within the sleeve portion of the spray-head and with its other end engaging a projection on the annular flange of the filter holder.

It is an object of the present invention to provide a method and equipment for applying a liquid product or other fluent material onto a household article for purpose of cleaning, coating, polishing, fabric treatment and the like with reduced mess, overspray and improved safety. It is another object of the present invention to provide a method and equipment for watering a household plant with reduced mess, overspray and improved safety. By ‘watering’ is meant the delivery of an aqueous liquid to any part of the plant, including the root system and surroundings soil but preferably to the leaves and more preferably to both sides of the leaves. The liquid can be water itself or any aqueous or non-aqueous liquids suitable for household article or plant care. Aqueous liquids are preferred herein but non-aqueous liquids such as oil based products or emulsions/suspensions can also be used. By overspray is meant the percentage by weight of liquid that lands on the household article or plant surroundings (excluding the soil). The method and equipment of the invention involves the use of an electrically charged spray. The spray is obtained by a balance of hydrodynamic, gravitational, electrical and drag forces in such a way that the generated spray droplets deposit preferentially onto the surface of the household article or target plant. The forces acting on the spray droplets are mainly determined by: i) the physical properties of the, such as surface tension, density and viscosity, ii) the initial conditions of the liquid, such as pressure gradient and flow rate and iii) the electrical condition of the liquid such as resistivity and applied potential.

One of the factors that has been found to determine the amount of overspray in electrostatic spraying and plant watering systems is the spray trajectory. In particular, improved deposition and reduced overspray at high application rates is obtained when spraying in a generally upward or downward direction using spray droplets of defined size, exit velocities and charge.

It has been surprisingly found that optimum watering and liquid delivery is obtained using droplets size of at least about 40 μm and preferably in the range from about 75 to about 500 μm when the liquid is discharged upwardly at an exit velocity in the range from about 3 to about 40 m/s, preferably from about 3 to about 20 m/s and at an applied potential in the range from about 0.2 to about 50 kV. Such embodiments, are sometimes referred to herein as “upward spray” or “watering can” mode embodiments.

Thus, according to another aspect of the present invention, there is provided a method for applying a liquid product onto a household article for purpose of cleaning, wetting, coating, polishing, fabric treatment and the like with reduced overspray or a method of watering a household plant with an aqueous liquid suitable for plant care and with reduced overspray, the method comprising discharging the liquid in the form of an upwardly directed spray of droplets having an average droplet size of at least about 40 μm and preferably in the range from about 75 to about 500 μm and at a proximal distance of from about 0.1 to about 1 m from the household article or plant, the liquid being delivered at an exit velocity in the range from about 3 to about 40 m/s, preferably from about 3 to about 20 m/s and at an applied potential in the range from about 0.2 to about 50 kV, whereby the overspray is less than about 40%. As used herein, exit velocity refers to the velocity of liquid exiting the orifice or orifices of the spray nozzle and is equal to the flow rate divided by the cross-sectional area of the orifice or orifices. Average droplet size on the other hand is measured using a Malvern Size Analyser, and refers to the average droplet size measured at a distance of 10 cm from the orifice or orifices of the nozzle.

In preferred upward spray mode embodiments of the invention the exit velocity is from about 4 m/s to about 15 m/s and more preferably from about 5 m/s to about 12 m/s and the spray of droplets is upwardly directed at a spray angle of from about 20° to about 70°, preferably from about 30° to about 60° to the vertical. As used herein, spraying angle refers to the direction of the liquid immediately prior to ejection from the nozzle orifice and, in the case of multiple orifices, is the average spray angle for the different orifices.

The invention herein can also be applied to liquid delivery and plant watering methods and equipment in so-called “downward-spray” or “shower” mode. Thus, according to a further aspect of the invention, there is provided a method for applying a liquid product onto a household article for purpose of cleaning, wetting, coating, polishing, fabric treatment and the like with reduced overspray or a method of watering a household plant with an aqueous liquid suitable for plant care and with reduced overspray, the method comprising discharging the liquid through a spray nozzle in the form of a downwardly directed spray of droplets having an average droplet size of at least about 40 μm and preferably in the range from about 75 to about 500 μm and at a proximal distance of from about 0.1 to about 1 m from the household article or plant, the liquid being discharged through the spray nozzle at an exit velocity in the range from about 0 to about 2 m/s and at an applied potential in the range from about 0.2 to about 50 kV, whereby the overspray as herein defined is less than about 40%.

In preferred downward-spray mode embodiments of the invention the exit velocity is from about 0.1 m/s to about 1.5 m/s, preferably from about 0.5 m/s to about 1 m/s and the spray of droplets is downwardly directed at a spray angle of from about −30° to about 30°, preferably from about −15° to about 15° to the vertical.

In both “upward-spray” and “downward-spray” modes of operation, the overspray should be less than about 40%, preferably less than about 30% and more preferably less than about 20% by weight. Overspraying can be measured by weighing the amount of liquid that deposits onto the target system (eg a potted plant) and subtracting from the total discharged liquid.

Of course, the system can work in a standard horizontal mode as well with the spray directed at +/−15° to the horizontal and an exit velocity of from about 4 m/s to about 15 m/s and more preferably from about 5 m/s to about 12 m/s. However, this mode can result in slightly more overspray because of inertial effects, with overspray of less then 50%, preferably less than 30%, and more preferably less than 20%. The spray is generated by delivering the liquid to the spray nozzle under a combination of electrical and hydrodynamic forces. The liquid is charged at or prior to the nozzle orifice or orifices by passing through an electrical field generated by a charged electrode. The electric field strength is mainly dependent upon the voltage applied to the electrode and the distance from the target. The liquid can be delivered to the nozzle by any means, but is preferably delivered hydrodynamically, for example with external mechanical work input so as to provide an operating or total pressure greater than the static pressure of the fluid in the system. Preferably the liquid is delivered by hydraulic pressure using a pump, especially preferred being a peristaltic pump. Typically a suitable pump would have an operating pressure in the range from about 5 to about 2000 kPa, preferably from about 10 to about 1050 kPa, and more preferably from about 50 to about 150 kPa. The threshold values of the pressure control valve are adjusted accordingly. The discharge capacity of the equipment (defined as flow rate/orifice) on the other hand, is preferably at least about 0.1 mL/min/orifice, more preferably from about 0.2 to about 20 mL/min/orifice, yet more preferably from about 0.5 to about 10 mL/min/orifice and especially from about 1 to about 5 mL/min/orifice.

Plant care products include any liquid based composition used to treat plants, for example pesticides, insecticides, herbicides, fungicides, plant growth enhancers, plant food, plant nutrients, plant cleaners, leaf varnishes, plant shine agents, water and mixtures thereof. Although any liquid base could be used herein, aqueous solutions are preferred in the present invention. Suitable products for delivery to inanimate household articles include, for example, hard surface cleaning products, cleaning products for curtains, walls, venetian blinds, silver care products, floor and furniture polishes, glass and window cleaning products, fabric treatment products, ironing products, stain removal products, fabric care products, laundry products, bleaching products, bathroom and kitchen cleaning products, etc. Suitable products for personal or non-human animal use include, for example, cosmetics, sun-screens, moisturizers, deodorants, color cosmetics, make-up compositions, wound care compositions, shampoos, etc. Many of these products are highly conductive aqueous liquids and have a resistivity lower than about 10⁴ ohm cm. Higher resistivity liquids can also be successfully sprayed using the present method and equipment.

Most of the plants found in the household environment are potted, either in a plastic pot or in a ceramic pot. Both materials are insulators, whereby “insulator” or “insulating material” refers to a material having a resistivity generally above about 10¹² ohm cm. Therefore, the pot insulates the plant and as consequence it will not attract charged particles. If a liquid is electrostatically sprayed in the proximity of a potted plant, the spray will be as likely to go to the plant surroundings as to the plant. In one method for watering a potted plant, therefore, watering is carried out using an alternatively positively and negatively charged spray. In another method, the circuit is completed by using grounding means such as a spike inserted in the soil in the vicinity of the plant. This makes the spray preferentially go to the plant and soil in the pot, thus avoiding undesirable mess and product waste.

Other articles found in the household environment can also be classified as insulators (for instance, glass ornaments, windows and plastics objects). Insulators can be electrostatically sprayed, for instance, by using an alternatively positively and negatively charged spray. Other articles can be classified as semi-insulators materials (for instance furniture and cloth) whereby “semi-insulator” or “semi-insulating material” refers to an object or material having a resistivity generally between about 10⁷ and about 10¹² ohm cm. Semi-insulators and insulators can be electrostatically sprayed, for instance, with the help of grounding means such as clamps, pins or other fastening means attached to the object as described hereinabove.

The equipment and methods of the present invention can be applied to both inside plants, i.e., plants normally growing inside buildings such as houses, greenhouses, workplaces, etc, or outside plants, for example plants growing in a garden, allotment, plant nursery, patio, etc. The term “household plant” is to be construed accordingly. In general, however, the method is applied to individual household plants or where a number of household plants are being watered, the individual plants will usually be treated sequentially. Similarly, the equipment and methods of the present invention can be applied to articles both inside and outside the house, workplace, etc, to both inanimate and animate articles (human and non-human animals) and to items which are not necessarily always in the house but which have a more general household association, e.g. bicycles, cars, etc. The term “household article” is to be construed accordingly.

A highly preferred method of the invention includes the additional step of shaping the spray using spray shaping means, the spray shaping means comprising either a) an insulating element whereby in use the first droplets to contact the element generate an electrostatic field for shaping the spray, or b) a conductive element whereby in use the element is charged so as to generate an electrostatic field for shaping the spray. In a preferred spray shaping method, the spray shaping means comprises an insulating element in the form of a surface or surface covering extending generally under and around the household article or plant. Suitable insulating elements include, for example, the surface of a table which is insulated from ground or an insulated mat which is designed to be placed on a surface and on which the household article or plant is placed. Suitable insulating elements also include mats in the form of an annulus wherein the household article or plant is located in the central region of the mat. Suitable spray shaping means also include spray deflector means, situated adjacent the nozzle orifice as described in detail below.

Thus according to another aspect of the invention, there is provided a method for applying a liquid product onto a household article or plant for purpose of cleaning, wetting, coating, polishing, fabric treatment, plant watering and the like, the method comprising discharging the liquid through a spray nozzle in the form of a spray of droplets at an applied potential in the range of from about 0.2 to about 50 kV and thereafter electrically shaping the spray of droplets whereby the overspray as herein defined is less than about 40%, preferably less than about 30% and more preferably less than about 20%.

The present invention also relates to electrostatic spray equipment, especially plant watering and other hand-held equipment suitable for use within the home for application of liquids to household articles or plants with improved coverage and reduced overspray. Thus according to a further aspect of the invention there is provided an electrostatic spray equipment comprising:

a) a reservoir for containing a liquid suitable for application to a household article or plant for purpose of cleaning, wetting, coating, polishing, fabric treatment, plant watering and the like;

b) a nozzle in fluid communication with the reservoir and having at least one orifice for generating a spray of droplets;

c) means for delivering the liquid from the reservoir to the nozzle;

d) means for electrically charging the liquid; optionally

e) means for adjusting the orientation of the nozzle orifice relative to the apparatus; and further optionally

f) means for electrically shaping the spray of droplets after generation thereof.

The electrostatic spray equipment of the invention can be deployed in a number of ways but is preferably used in one of two modes:

a) an upward mode wherein the apparatus is arranged to discharge the liquid in the form of an upwardly directed spray of droplets having an average droplet size of at least about 40 μm and preferably in the range from about 75 to about 500 μm, the liquid being discharged through the spray nozzle at an exit velocity in the range from about 3 to about 40 m/s, preferably about 3 to about 20 m/s and at an applied potential in the range from about 0.2 to about 50 kV; and

b) a downward mode wherein the apparatus is arranged to discharge the liquid in the form of a downwardly directed spray of droplets having an average droplet size of at least about 40 μm and preferably in the range from about 75 to about 500 μm, the liquid being discharged through the spray nozzle at an exit velocity in the range from about 0 to about 2 m/s and at an applied potential in the range from about 0.2 to about 50 kV.

The spray nozzle can have different configurations and geometries, a circular orifice cross-section produces a good spray. In the case of spray nozzles having a single orifice, the nozzle orifice preferably has an outlet diameter is in the range of from about 20 μm to about 300 μm, preferably from about 100 μm to about 200 μm. Multiple orifice nozzles on the other hand preferably have an outlet diameter in the range from about 20 μm to about 250 μm, preferably from about 20 μm to about 100 μm. In highly preferred embodiments, the electrostatic spray equipment includes means for adjusting the relative orientation of the nozzle orifice in order that the equipment can be used at a spray angle that can be selected by the end-user. By relative orientation is meant the orientation of the nozzle orifice relative to the remainder of the device. In preferred embodiments, the nozzle is in fluid communication with the reservoir via a conduit and the means for adjusting the relative orientation of the nozzle orifice comprise a flexible portion of the conduit such as a flexible neck hose or tubing. The nozzle is enclosed in a flexible tube in order to have complete freedom of orientation. Preferably, the nozzle orifice or orifices are surrounded by an annular or conical spray deflector means, typically made of an insulating or semi-insulating material. However, the deflector could be flat or another shape as well. The deflector is charged by the spray, due to its insulating nature the charge will stay in the surface therefore repelling further spray. The provision of deflector means adjacent to the nozzle orifice is valuable for electrically shaping the spray of droplets and for controlling the width of the spray. In addition, the deflector can accelerate the velocity of the spray by focusing the electrical field.

The electrostatic spray equipment can further comprises household article or plant grounding means as described hereinabove in order to improve the attractive capacity of the household article or plant towards the spray. Suitable plant grounding means includes, for example, a spike placed in the soil and connected either to the device or to earth. Other suitable grounding means includes, for example, an electrode in the form of clamps which in use is attached to the household article or plant and connected either to the equipment or to earth. Another way to ground the household article or plant is by introducing a permanently charged electrode, preferably an electrode of opposite charge to the droplets being sprayed.

The electrostatic spray equipment can also comprise spray shaping means to improve the selective deposition of the spray on the household object or plant. The role of the shaping means is to bring back to the household object or plant the spray droplets that would otherwise miss the target. The shaping means can be an insulator or a conductor. If it is an insulator, it will be charged with the same sign electrical charge as the spray, therefore it will repel further spray and this spray is redirected to the target. If it is a conductor, current of the same sign as the spray charge needs to be constantly supplied in order to keep the conductor permanently charged.

The grounding means and spray shaping means can be either integral with the spray equipment or separate therefrom. Accordingly, the present invention also includes electrostatic spray kits comprising the electrostatic spray equipment, grounding means and/or shaping means. The grounding means may take the form of an electrode connectable to the ground of the equipment or to earth or one which in use can be charged with opposite charge to the spray droplets, etc.

It will be understood of course that the equipment of the invention can include one or more reservoirs and/or one or more spray nozzles in fluid communication with the one or more reservoirs. Multiple reservoirs are valuable in the case of household article or plant care products which are mutually incompatible or which are designed for application to the household article or plant in sequential manner. Multiple nozzles are valuable in the case of multiple household article or plant care products requiring different application characteristics or for simultaneous application of household article or plant care products designed to interact with one another on the household article or plant or for applying higher flow rates of product where a single nozzle can not provide enough flow.

The electrostatic spray equipment is preferably designed from the ergonomic viewpoint so as minimize operator fatigue and enhance in-use safety. To this end, the weight of the device should be as low as possible, preferably less than about 2000 g, more preferably less than about 500 g, and ideally about 200 g. Again the motor should be positioned away from the hand to minimize vibration; and hand functions, e.g. for holding the equipment and for pushing a start/stop button should be separated.

### DETAILED DESCRIPTION OF THE INVENTION

Convenient for use herein are plant care products in the form of aqueous solutions, including water. The plant watering methods and equipment of the present invention allow for relatively high application rates whilst at the same time reducing or avoiding overspray. It has also been found that some plants respond positively to electrically charged liquid and can display improved growth rates. The increased growth may be due to the electrically charged liquid causing biostimulation in the plants. Usually plant care products for use in house interiors are diluted aqueous solutions, having a low resistivity, sometimes lower than that of pure water, due to the presence of ions in solution. The efficiency of pesticides, insecticides and fungicide can also be improved according to the invention as a result of improved underleaf coverage. This is important since insects and diseases are located very often on leaf undersides and other hidden areas difficult to reach with traditional spraying methods.

The method of the present invention can be put into practice by using an electrostatic spray device comprising means to deliver the liquid, means to electrically charge the liquid and means for generating a spray of charged droplets. The invention will now be described by way of example with reference to the accompanying drawings in which:

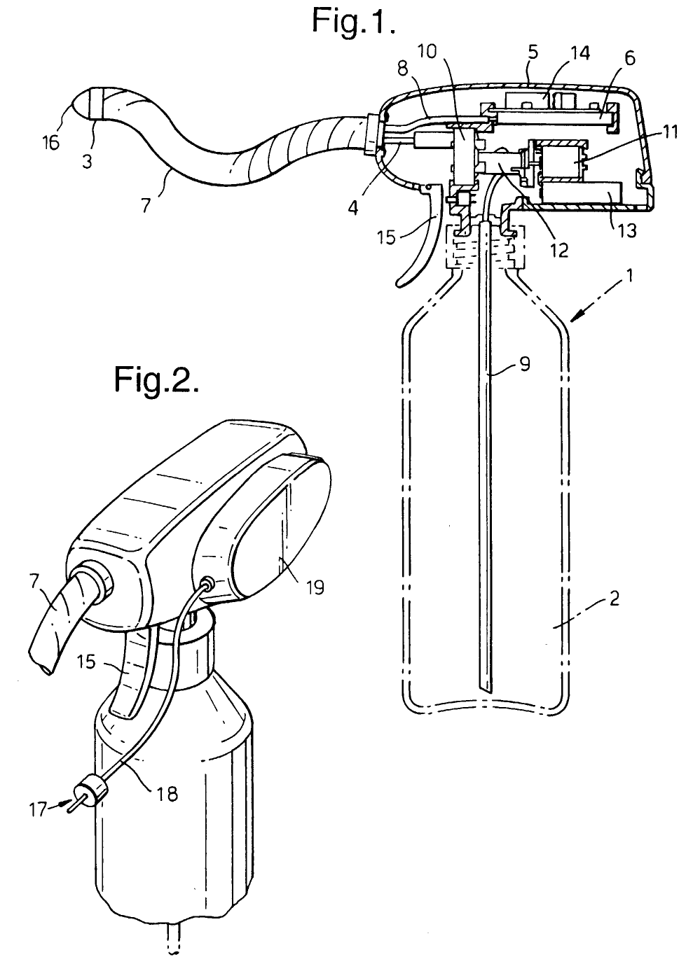

FIG. 1 is a cross-sectional view of one embodiment of the electrostatic spray equipment with a perspective view of the flexible neck;

FIG. 2 is a fragmentary perspective view of the embodiment of FIG. 1 showing the grounding spike and grounding spike cord retraction mechanism; and

FIG. 3 is a cross-sectional view of a nozzle assembly suitable for use in the electrostatic spray equipment.

Preferably, the droplets are positively charged. If desired however, the droplets can be negatively charged. The electrostatic spray equipment is preferably constructed in a size, shape and weight convenient for hand-held use and for easy manipulation. The equipment of FIG. 1 generally comprises housing 1, liquid reservoir 2, nozzle 3, means 4 to deliver the liquid to the nozzle, cap-like compartment 5 which encases electrical means 6 to generate high voltage and flex-neck tube 7 providing a conduit to nozzle 3 and incorporating high voltage lead 8. In the illustrated embodiment, housing 1 has the shape and dimensions of a conventional spray bottle used for cleaning products and which is preferably electrically insulating, e.g. plastic material, within which the electrical and other hardware components of the apparatus are mounted.

In this embodiment, liquid reservoir 2 is mounted beneath cap-like compartment 5 and is a bottle type reservoir which can be easily refilled or replaced when necessary. The composition to be sprayed is fed through dip-in-tube 9. If desired or as necessary, the apparatus may include feed means such as a hand pump, electrical pump (especially a peristaltic pump), pressurised gas, etc, to transfer composition from reservoir 2 to nozzle 3 at the required rate. Typically a positive pressure of from about 10 to 1050 kPa, preferably from about 50 to about 150 kPa will be suitable for this purpose. In the illustrated embodiment a pump 10 with motor 11 and gear box 12 is used to control the outlet flowrate.

In the illustrated embodiment, electrical means 6 to generate high voltage is located towards the top of the equipment in cap-like compartment 5. Towards the base of the cap-like compartment is housed battery 13, such as a conventional low voltage, e.g. 1.5 to 12, particularly 9, volts, cell, which location allows ready access to the battery for the purpose of replacement when necessary. High voltage generator 6 converts the low voltage from battery 13 into the high voltage of for example between about 12 and 18 kilovolts, which is required for raising the product to be sprayed to the high electric potential necessary to effect electrostatic spraying thereof.

Suitable components of high voltage generator 6 are well known in the art and comprise principally a coil or transformer to perform the voltage step-up function. A “charge pump” or “ladder”-type voltage multiplier, which consist primarily of diodes and capacitors, may be used in isolation or in conjunction with said coil or transformer. This multiplier can be of serial or parallel construction. If desired or as necessary, various packing elements of electrically insulating material, not shown in FIG. 1, may be provided in order to increase the safety aspect of the high voltage apparatus and to reduce unwanted leakage paths to earth when the apparatus is in use.

Above high voltage generator 6 are one or more circuit boards 14 containing any necessary auxiliary electrical component for ensuring effective and satisfactory functioning of the apparatus. Such additional circuit board(s) 14 may comprise for example DC/AC (or vice versa) converters, as well as voltage adjustment means to control the high voltage applied to the product delivery means from which the product to be sprayed is to be delivered. High voltage generator 6 is connected through a high voltage lead 8 to a charge transfer piece (not shown) which contacts the liquid before leaving the orifice of nozzle 3. High voltage lead 8 and the fluid conduit are enclosed within insulating flex neck tube 7. Flex neck tube 7 allows the end-user to orient nozzle 3 in any desired direction relative to the remainder of the device. Of course, flex neck tube 7 could be replaced with a rigid tube with a fixed position to enforce use at a preferred angle. Nozzle 3 comprises an internal chamber (not shown) which terminates at the tip of nozzle 3 in an orifice 16 from which the product within the chamber emerges under the influence of electrostatic and hydrodynamic forces. The configuration of nozzle 3 in the region of orifice 16 may be selected in association with other spraying parameters in order to give an optimised system both as regards spray properties and safety. Nozzle 3 with circular orifice has been found very useful for the present application, the diameter of the orifice being in the range from about 50 μm to about 500 μm, preferably from about 100 μm to about 300 μm. In a preferred embodiment, the nozzle is surrounded by spray deflector (not shown), which can be an insulating or semi-insulating material in the form of for example a tube that goes over the spray nozzle. On use of the equipment spray deflector becomes charged, forcing the spray droplets away from the device and the user by creating an electrostatic field that has the same charge as the spray.

Shown schematically in FIG. 1 as 15 is a manual trigger which constitutes control means for selectively switching on the unit to apply the high voltage to the nozzle to electrostatically spray the product therefrom. Trigger 15, like the other elements of the apparatus subject to unwanted voltage leakage or shock risk, is preferably constructed and situated to minimise such problems, expedients for which are known in the art.

In alternative embodiments of the equipment, the liquid reservoir can be placed above the cap-like compartment in order to take advantage of the gravity force for the liquid flow.

As illustrated in FIG. 2, electrostatic spray equipment in FIG. 1 can further comprises a household article or plant grounding device or other grounding means for purposes of charge dissipation and in order to improve the attractive capacity of the household article or plant towards the spray. In the illustrated embodiment, the grounding device takes the form of grounding spike or other fastening means 17 which is electrically connected with connector cord 18 to the ground of the equipment. Cord retracted mechanism 19 is housed on one side of cap-like compartment 5. Other embodiments to accomplish grounding of the household article or plant include earthing the household article or plant and providing the household article or plant with a charge opposite to that of the spray.

The electrostatic spray equipment can be used in conjunction with a spray shaping device (not shown) to improve the selective deposition of the spray on the household article or plant. The role of the shaping device is to bring back to the household article or plant spray droplets that miss the target. The shaping device can be an insulator or a conductor. If it is an insulator, it will be charged with the same sign electrical charge as the spray, therefore it will repel further spray and this spray can be redirected to the household article or plant. If it is a conductor, current of the same sign as the spray charge needs to be constantly delivered to the conductor in order to keep it permanently charged.

FIG. 3 illustrates a preferred embodiment of a nozzle assembly 20 suitable for use herein. In general terms, nozzle assembly 20 comprises filter 21, pressure control valve 22 and spray-head 23 mounted within housing 24 equipped with fluid inlet port 25 and high voltage supply port 34 at the inlet end of housing 24 and with detachable hood or shroud 26 at the outlet end of housing 24 and which acts as a deflector or shaping device for the spray. The hood or shroud 26 is secured to housing 24 by screw engagement means on the outlet end of the housing and is detachable from the housing in order to permit disassembly of the nozzle. Spray-head 23 is mounted at the outlet end of housing 24 and comprises orifice portion 27, sleeve portion 28 and circumferential lip portion 29. Filter 21 is mounted at the inlet end of housing 24 and comprises filter element 30 and filter holder 31 having annular flange 32. Pressure control valve 22 is mounted intermediate spray-head 23 and filter 21. When assembled, hood or shroud 26 bears on circumferential lip portion 29 of spray-head 23 while the outermost portion of annular flange 32 of filter holder 31 bears on sleeve portion 28 of spray-head 23, whereby hood or shroud 26 and filter holder 31 together act to hold spray-head 23 in position within housing 24. Pressure control valve 22 on the other hand is mounted with one end within sleeve portion 28 of spray-head 23 and with its other end engaging a projection 33 on annular flange 32 of filter holder 31.

In use, a potted plant (in a plastic container) is watered using the equipment shown in FIG. 1. Optionally, the potted plant is placed on an insulated Perspex sheet of circular geometry (0.5 m diameter). The plant is grounded by placing the ground spike (shown in FIG. 2) in the soil. The user holds the electrostatic spray equipment and manipulates flex neck tube 7 such that the nozzle orifice is approximately 0.5 m from the plant and inclined upwardly over the plant at an angle of 30° to the vertical. The liquid is charged to an applied potential of about 8 kV and discharged from the spray nozzle at an exit velocity of about 10 m/s. The mean particle size of the droplets 10 cm from the nozzle orifice is 200 μm as measured by a Malvern Size Analyser. The amount of overspray (the amount of water not landing on the potted plant) is 20%.

The electrostatic spray equipment can be used in similar manner for applying a variety of different consumer products to household articles. For example, in one method of use, an ironing composition comprising a mixture of ironing aids, perfume and water, is sprayed onto a laundry item prior to or during ironing in the following manner. The laundry item is first placed on an ironing table or board having a conducting surface connected to the earth of the spray equipment. The user holds the electrostatic spray equipment and manipulates flex neck tube 7 such that the nozzle orifice is approximately 0.5 m from the laundry item and inclined upwardly over the item at an angle of 30° to the vertical. The liquid is charged to an applied potential of about 8 kV and discharged from the spray nozzle at an exit velocity of about 10 m/s. The mean particle size of the droplets 10 cm from the nozzle orifice is 200 μm as measured by a Malvern Size Analyser. The amount of overspray (the amount of composition not landing on the laundry item) is 20%.

What is claimed is:

1. Electrostatic spray equipment for use in applying a liquid to a household article comprising:
a) a reservoir for containing a liquid;
b) a nozzle in fluid communication with the reservoir having at least one orifice for generating a spray of droplets;
c) means for delivering the liquid from the reservoir to the nozzle;
d) means for controlling the spray equipment;
e) means for electrically charging the liquid, said means comprising a generator having a first voltage output and a second voltage output, wherein the first voltage output is in excess of the second voltage output; and
f) means for grounding a household article for purpose of charge dissipation, said means for grounding comprising:
i) a connector in electrical contact with the second voltage output of the generator, wherein the connector is maintained at an electrical potential in the range of from about 0 kV to about 50 kV; and
ii) a fastening means capable of electrical contact with the household article and the connector, wherein said electrical contact is sufficient to establish a charge-dissipation grounding loop during operation of the spray equipment.

2. The electrostatic spray equipment of claim 1 wherein said fastening means and said connecter are releasably connected, the fastening means is capable of being electrically isolated from the connector, and wherein in use the connector and fastening means are brought into electrical connection in order to establish a charge-dissipation grounding loop.

3. The electrostatic spray equipment of claim 1 wherein the connector comprises elements selected from the group consisting of an electrically-conductive wire having a length selected to control the maximum permissible spraying distance between the equipment and the household article, indicia to provide the user with a visual indication of the spraying distance, and mixtures thereof.

4. The electrostatic spray equipment of claim 1 wherein the fastening means is selected from the group consisting of a substantially cylindrical pin, a substantially flat or planar plate, an adhesive strip, or mixtures thereof.

5. The electrostatic spray equipment of claim 1 wherein the means for controlling the spray equipment additionally comprises one or more means selected from the group consisting of means for switching the equipment on or off, means for regulating delivery of the liquid from the reservoir to the nozzle, means for controlling spray application rate, means for controlling spray direction, means for controlling spray trajectory, means for controlling the shape and/or size of the spray pattern, means for storing operational and/or environmental information, means for computing optimum operational characteristics, and mixtures thereof.

6. The electrostatic spray equipment of claim 1 wherein the spray equipment additionally comprises means for providing feedback of operational or environmental information to the group consisting of the spray equipment control means, a spray equipment operator, and combinations thereof.

7. The electrostatic spray equipment of claim 6 wherein the electrostatic spray equipment additionally comprises sensing means, for sensing operational and/or environmental conditions, and communication means for communicating information collected by the sensing means to the group consisting of the spray equipment control means, the operator, and combinations thereof.

8. The electrostatic spray equipment of claim 7 wherein the household article is a plant and wherein the sensing means collects operational and/or environmental data comprising data selected from the group consisting of atmospheric humidity, atmospheric temperature, soil pH, soil moisture content, soil salinity, soil nutrient level, and mixtures thereof, and wherein in response to the operational and/or environmental data collected by the sensing means the control means is able to perform functions comprising functions selected from the group consisting of switching the spray equipment on or off, regulating delivery of the liquid from the reservoir to the nozzle, regulating spray characteristics, preventing the spray equipment from switching on unless the connector is electrically connected to the fastening means, and combinations thereof.

9. The electrostatic spray equipment of claim 8 wherein the communication means comprises communication means selected from the group consisting of wire-based communication means, optical fibre communication means, radio frequency communication, infra-red communication means, and mixtures thereof.

10. A kit comprising the electrostatic spray equipment of claim 1, a household article, a fastening means, and optionally a spraying shaping means.

11. The kit of claim 10 wherein the grounding means of the electrostatic spray equipment comprises an electrode releasably connectable to the household article.

12. The kit of claim 11 wherein the household article is a plant in soil and the electrode is releasably connectable to the soil.

13. The kit of claim 10 wherein the grounding means comprises an electrode which in use can be charged oppositely than the charge of the spray of droplets.

14. The kit of claim 10 wherein the electrostatic spray equipment comprises a spray shaping means, wherein the spray shaping means comprises an insulating element whereby in use a first spray of droplets contacts the insulating element and generates an electrostatic field for shaping a second spray of droplets.

15. The kit of claim 10 wherein the electrostatic spray equipment comprises a spray shaping means, wherein the spray shaping means comprises a conductive element whereby in use the conductive element is charged so as to generate an electrostatic field for shaping the spray of droplets.

16. A method applying a liquid to a household article comprising the steps of:
A) providing electrostatic spray equipment comprising:
i) a reservoir for containing a liquid;
ii) a nozzle in fluid communication with the reservoir having at least one orifice for generating a spray of droplets;
iii) means for delivering the liquid from the reservoir to the nozzle;
iv) means for controlling the spray equipment;
v) means for electrically charging the liquid, said means comprising a generator having a first voltage output and a second voltage output, wherein the first voltage output is in excess of the second voltage output; and
vi) means for grounding a household article for purpose of charge dissipation, said means for grounding comprising:
a) a connector in electrical contact with the second voltage output of the generator, wherein the connector is maintained at an electrical potential in the range of from about 0 kV to about 50 kV; and
b) a fastening means capable of electrical contact with the household article and the connector, wherein said electrical contact is sufficient to establish a charge-dissipation grounding loop during operation of the spray equipment.
B) bringing the household article into electrical contact with the fastening means;
C) bringing the connector and fastening means into electrical connection in order to establish a charge-dissipation grounding loop.

17. The method of claim 16 wherein the spray equipment additionally comprises means for providing feedback of operational or environmental information to the spray equipment control means or to the operator for the purpose of controlling the equipment or for advising the operator of operational and/or environmental conditions.

18. The method of claim 17 wherein the electrostatic spray equipment additionally comprises sensing means, for sensing operational and/or environmental conditions, and communication means for communicating information collected by the sensing means to the group consisting of the spray equipment control means, the operator, and combinations thereof.

19. The method of claim 18 wherein the household article is a plant and wherein the sensing means collects operational and/or environmental data comprising data selected from the group consisting of atmospheric humidity, atmospheric temperature, soil pH, soil moisture content, soil salinity, soil nutrient level, and mixtures thereof, and wherein in response to the operational and/or environmental data collected by the sensing means the control means is able to perform functions comprising functions selected from the group consisting of switching the spray equipment on or off, regulating delivery of the liquid from the reservoir to the nozzle, regulating spray characteristics, preventing the spray equipment from switching on unless the connector is electrically connected to the fastening means, and combinations thereof.

20. The method according to according to claim 18 wherein the communication means comprises communication means selected from the group consisting of wire-based communication means, optical fibre communication means, radio frequency communication, infra-red communication means, and mixtures thereof.
